(19) United States
(12) Patent Application Publication
(10) Pub. No.: US 2019/0162673 A1
(43) Pub. Date: May 30, 2019

(54) OPTICAL INSPECTION SYSTEM AND IMAGE PROCESSING METHOD THEREOF

(71) Applicant: Creative Sensor Inc., Taipei City (TW)

(72) Inventors: Li-Cheng HSU, Taipei City (TW); Chai-Wei WANG, Taipei City (TW); Chiu-Kai TAI, Taipei City (TW)

(21) Appl. No.: 15/828,359

(22) Filed: Nov. 30, 2017

(51) Int. Cl. G01N 21/88; G06T 7/00; G06T 5/50; G06T 1/00

(52) U.S. Cl. CPC G01N 21/8806; G06T 7/0004; G06T 5/50; G06T 1/0007; G06T 2207/30136; G06T 2207/20221; G06T 2207/30141; G06T 2207/30148; G06T 2207/30124; G01N 2021/8825

(57) ABSTRACT

An optical inspection system includes at least one lighting module, a plurality of image-sensing units, and an editing and computing unit. Each lighting module is configured to generate a light beam for illuminating an object; each image-sensing unit is configured to capture an inspecting image of the object, wherein two adjacent inspecting images of the object has a repeated image; the editing and computing unit receiving the inspecting images captured by the image-sensing unit is configured to position the inspecting images in accordance with the repeated images and then recombinant the inspecting images for creating a full inspecting image.

### BACKGROUND

### Technical Field

The present disclosure relates to a metering apparatus by using an optical method. More particularly, the present disclosure relates to an image processing system and an image processing method.

### Description of Related Art

Automated optical inspection (AOI) is a high speed and precision optical imaging inspection system, which uses machine vision as the standard technology of inspection for overcoming the drawback of human inspection.

In general, after the tested object (for example, the semiconductor wafer) is well produced, an inspection process must be carried out; an exterior of the object is inspected by the automatic optical inspection device for determining whether a defect is appeared on the appearance of the object or not. More specifically, the automatic optical inspection is carried out by the optical inspection device, and during the inspection process, the object is illuminated with light, and the image of the object is captured by the image-sensing unit to determine whether the defect is existed or not.

In the past, automatic optical inspection captures images of the objected by surface-scanner mainly includes a lens and a camera, wherein the object in the field of view of the lens and the camera will be captured. However, the image resolution of the surface scanner is limited by the lens and the camera, and a poor resolution is generated while the field of view increases. Besides, the image capturing speed is too slow to meet the industrial needs.

### SUMMARY

According to one aspect of the present disclosure, an optical inspection system includes at least one lighting module, a plurality of image-sensing units, and an editing and computing unit. Each lighting module is configured to generate a light beam for illuminating an object; each image-sensing unit is configured to capture an inspecting image of the object, wherein two adjacent inspecting images of the object has a repeated image; the editing and computing unit receiving the inspecting images captured by the image-sensing unit is configured to position the inspecting images in accordance with the repeated images and then recombinant the inspecting images for creating a full inspecting image.

In an embodiment of the present disclosure, the editing and computing unit generates the full inspecting image by recombining the inspecting image provided by one of the image-sensing unit and multiple partial inspecting images provided by the other image-sensing units in accordance with the position of the inspecting images, and repeated images is not the partial inspecting images.

In an embodiment of the present disclosure, the editing and computing unit configured to form the full inspecting image by recombining a plurality of partial inspecting images provided the image-sensing units and the position of the inspecting images, the repeated image in the previous or following image-sensing units is not existed in the partial inspecting image.

In an embodiment of the present disclosure, the editing and computing unit performs a uniformity compensation procedure by a dark image and a brightness image.

In an embodiment of the present disclosure, the optical inspection system further comprises: a non-volatile memory coupled to the editing and computing unit and configured to store the dark image and white image, a volatile memory coupled to the editing and computing unit and configured to store the inspecting images, and an analog and digital conversion unit electrically connected between the image-sensing units and the editing and computing unit and configured to convert the inspecting image with analog form capture by the image-sensing units into digital inspecting image for convenient edition, operation, and storage.

In an embodiment of the present disclosure, the optical inspection system further comprises a driving unit coupled to the editing and computing unit and configured to transmit the full inspecting image to a computer.

In an embodiment of the present disclosure, the lighting module and the image-sensing unit are arranged at unilateral of the object, and each image-sensing unit is configured to capture the inspecting image generated by the object reflecting the light from the lighting module.

In an embodiment of the present disclosure, the lighting module and the image-sensing units are arranged at opposite side of the object, and each image-sensing unit is configured to capture the inspecting image generated by partial light from the lighting module and passing through the object.

In an embodiment of the present disclosure, the optical inspection system further comprising a light splitter arranged at an intersection of the optical route of the light generated by the lighting module and the inspecting image passing through.

In an embodiment of the present disclosure, the optical inspection system further comprises a plurality of lighting module arranged at the opposite side of the object and respectively generates light for illuminate the object, the image-sensing units captures the light reflected by and passing through the object to form the inspecting images.

According to another aspect of the present disclosure, an image-processing method applied to an optical inspection system comprises: capturing a plurality inspecting images from different source; sensing a plurality of repeated images from the inspecting images; positioning the inspecting images in accordance with the repeated images; and generating a full inspecting image in accordance with the positioned inspecting images.

In an embodiment of the present disclosure, the step of sensing a plurality of repeated images from the inspecting images further comprises performing a pre-procedure to the inspecting images to make the inspecting images with analog form into digital form.

In an embodiment of the present disclosure, further comprising performing a uniformity compensation procedure by a dark image and a brightness image.

### BRIEF DESCRIPTION OF DRAWING

The present disclosure can be more fully understood by reading the following detailed description of the embodiment, with reference made to the accompanying drawings as follows:

FIG. 1 is a perspective view of an optical inspection system according to a 1st embodiment of the present disclosure;

FIG. 2 is a side view of the optical inspection system according to the 1st embodiment of the present disclosure;

FIG. 3 is a partial enlarged view of an image-sensing unit according to the 1st embodiment of the present disclosure;

FIG. 4 is a circuit block diagram of an image-processing module according to the 1st embodiment of the present disclosure;

FIG. 5 is a side view of an optical inspection system according to a 2nd embodiment of the present disclosure;

FIG. 6 is a side view of an optical inspection system according to a 3rd embodiment of the present disclosure;

FIG. 7 is a side view of an optical inspection system according to a 4th embodiment of the present disclosure;

FIG. 8 is a side view of an optical inspection system according to a 5th embodiment of the present disclosure; and

FIG. 9 is a side view of an optical inspection system according to a 6th embodiment of the present disclosure.

### DETAILED DESCRIPTION

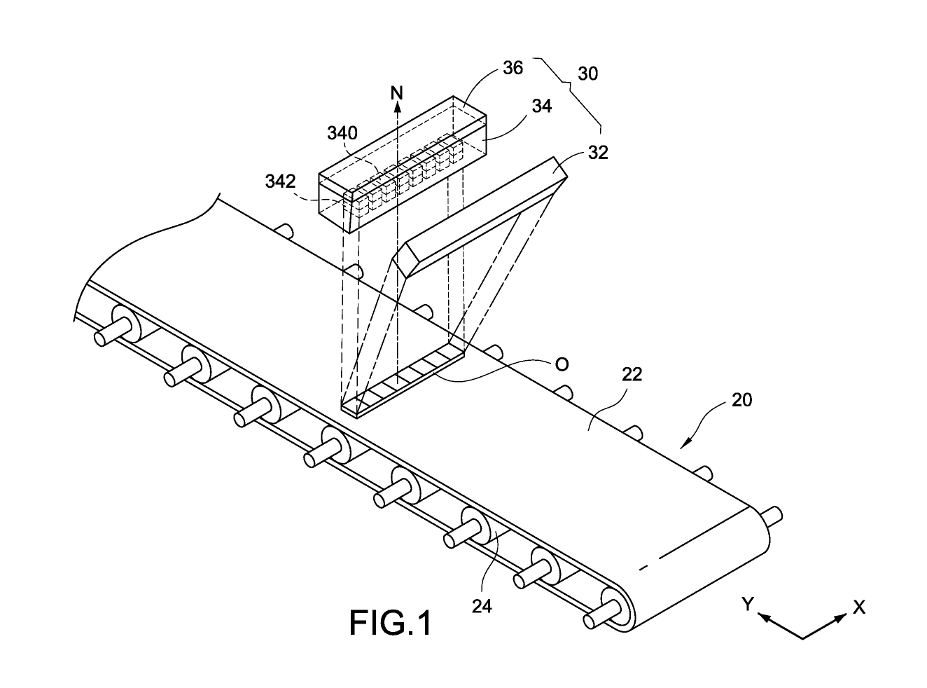

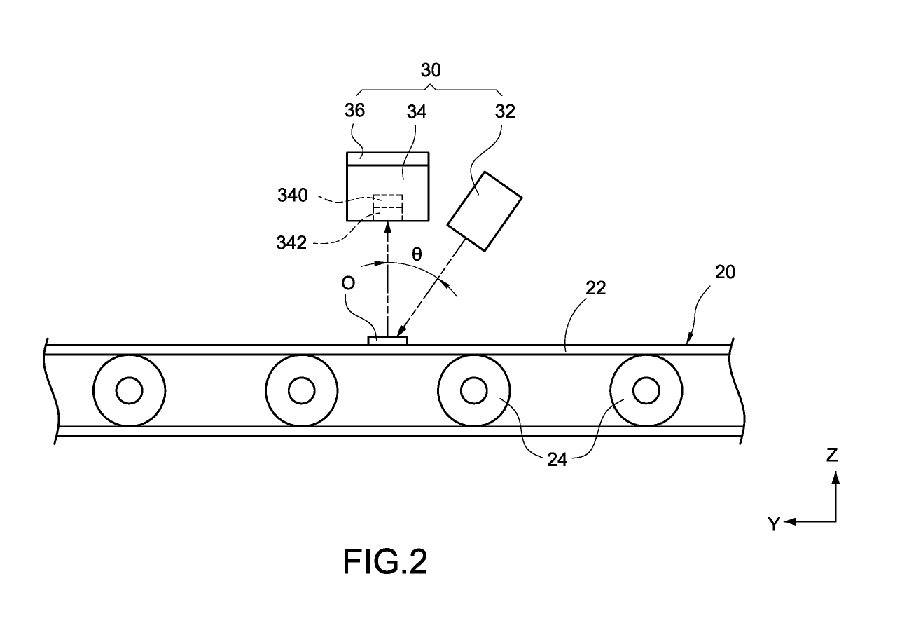

FIG. 1 is a perspective view of an optical inspection system according to a 1st embodiment of the present disclosure, and FIG. 2 is a side view of the optical inspection system according to the 1st embodiment of the present disclosure. In FIG. 1 and FIG. 2, the optical inspection system (its reference numeral is omitted) used for inspecting an object O includes a delivery device 20 and an optical-inspecting device 30. A conveyer belt 22 of the delivery device 20 moves the object O thereon to the optical-inspecting device 30 for inspecting defects like foreign object or scratch. The object O is, for example, a printed circuit board, a semiconductor chip, a panel, a textile good, a nonwoven, a steel plate, a glass, or the like.

The delivery device 20 further includes a plurality of rollers 24, and the conveyer belt 22 is trained around the rollers 24; a driver is in mechanical communication with the rollers 24 to facilitate movement of the conveyer belt 22 along a first direction Y, such that the object O is capable of moving to the optical-inspecting device 30. In the other words, delivery device 20 takes each object O arranged on the conveyor belt 22 moving.

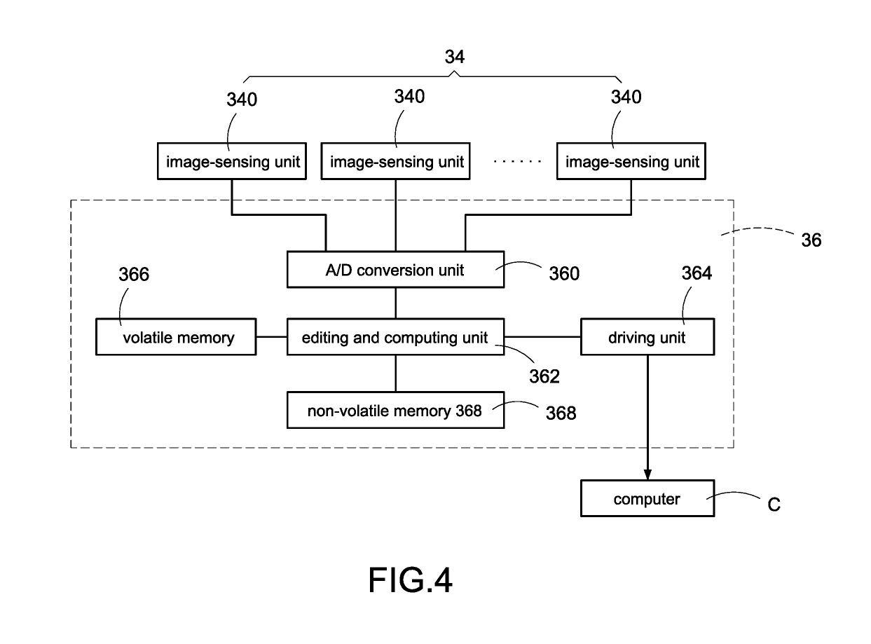

FIG. 4 is a circuit block diagram of an image-processing module according to the 1st embodiment of the present disclosure. For purpose of convenience of discussion, FIG. 4 further illustrates the image-sensing units 340. The optical-inspecting device 30 further comprises at least one lighting module 32, an image-capturing module 34, and an image-processing module 36; the lighting module 32 projects light to the conveyer belt 22 for illuminating the object O on the conveyer belt 22 and providing efficient light for the image-capturing module 34 to capturing image. In FIG. 2, the lighting module 32 is arranged at one side of the object O for providing a unilateral or one-sided of light.

The light provided by the lighting module 32 may be a linear light having a particular lighting angle, and the illuminant area of the light module completely covering the object O. the light module 32 may be implemented by a plurality of light emitting diodes, light tube(s), or light bulbs. In addition, the light module 32 may generate white light, visible light or invisible light with particular wavelength.

The image-capture module 34 has a particular view angle for capturing image of the illuminated object O. The image process unit 36 receives inspecting images of the object O captured by the image-capturing module 34 and configured to recombine the inspecting images for creating a full inspecting image; such that the object O can be determined to be a good object or defective object.

In FIG. 2, when an included angle between optical axes of the lighting module 32 and the image-capturing module 34 is 0, the following condition is satisfied:

1°≤θ<90°.

The axis of the image-capturing module 34 may be parallel to the normal N of the bottom (or top) surface of the object O. The length of the lighting module 32 at a second direction X perpendicular to the first direction Y is greater than that of the image-capturing module 34 for illuminating entire object O.

The image-capturing module 34 includes a plurality of image-sensing units 340, which can be charge-coupled devices (CCD) or complementary metal-oxide-semiconductor (CMOS) elements. The among of the image-sensing units 340 may be adjusted in accordance with the size of the object O; in general, the amount of the image-sensing units 340 is increased when the size of the object increases.

The image-sensing units 340 may be arranged along the second direction X. Each image-sensing unit 340 is configured to capture partial of inspecting image of the object O, and two inspecting images of the object O captured by two adjacent image-sensing units 340 has an overlapping area. In the other words, two inspecting images captured by two adjacent image-sensing units 340 include a repeated image. The image-capturing module 36 receives the inspecting images from each image-sensing unit 340 and configured to recombine the inspecting images to form the full inspecting image.

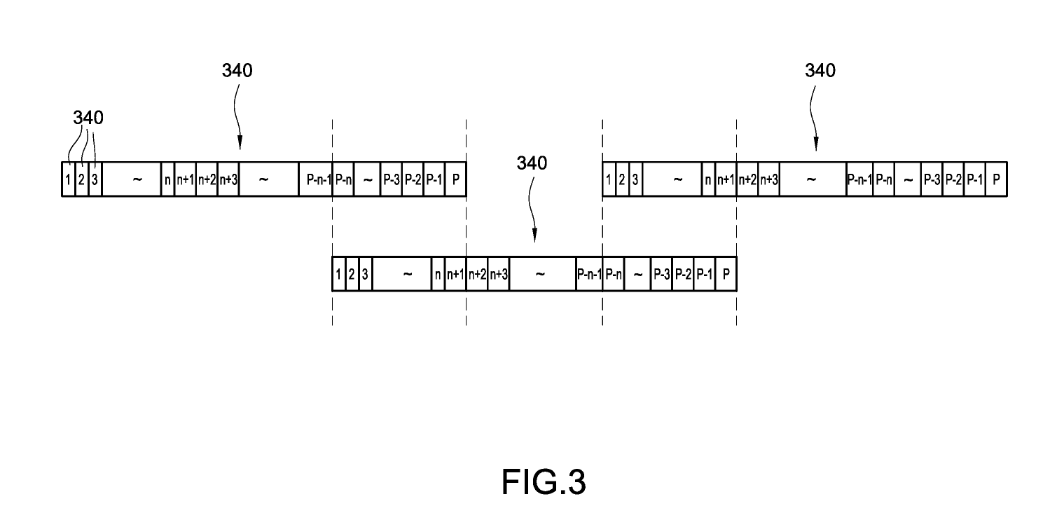

Each image-sensing unit 340 includes multiple pixels used for converting the image light reflected by the object O into inspecting image with analog form by photoelectron conversion. In the present invention, each image-sensing unit 340 may include P pixels (as shown in FIG. 3).

In order to provide the repeated image in the capturing images captured by two adjacent image-sensing units 340, the adjacent image-sensing units 340 may be staggered in the first direction Y to make partial pixels of the image-sensing units 340 overlap in the second direction X. For example, in FIG. 3, the P−n to P pixels of the left-most image-sensing unit 340 (or called the first image-sensing unit 340) respectively overlap the 1 to n+1 pixels of the central image-sensing unit 340 (or called the second image-sensing unit 340) in the second X and used for capturing the same inspecting images. Similarly, the P-n to P pixels of the central image-sensing unit 340 respectively overlap the 1 to n+1 pixels of the right-most image-sensing unit 340 (or called the third image-sensing unit 340) in the second X and used for capturing the same inspecting images, and so on. In short, in FIG. 3, except the left-most image-sensing unit 340, the 1 to n+1 pixels of the image-sensing units 340 respectively overlap the P-n to P pixel of the previous image-sensing units 340 for capturing the same inspecting images (i.e., the repeated images). Thus, a problem of discontinued full inspect image is overcome.

It should be noted that the method to make the inspecting images captured by two adjacent image-sensing units 340 has the overlapping area is not limited to staggered arranged the image-sensing units 340. In the practical applications, the image-sensing units 340 may linearly arranged in the second direction X, and arrange at least one lens between the image-sensing units 340 and the object O for enlarging an image-capturing area of each image-sensing unit 340, such that the overlapping area may exist in the inspecting images captured by two adjacent image-sensing units 340.

In addition, the image-sensing units 340 not position at the edge (left-most and right-most) of the image-capturing module can capture two repeated images, i.e., the inspecting image captured by 1 to n+1 pixels of the second image-sensing unit 340 is the same as that of captured by P−n to P pixels of the first image-sensing unit 340, and the inspecting image captured by P-n to P pixels of the second image-sensing unit 340 is the same as that of captured by 1 to n+1 pixels of the third image-sensing unit 340,

With referring to FIG. 4 again; the image processing module 36 further includes an analog to digital (A/D) conversion unit 360, an editing and computing unit 362, a driving unit 364, a volatile memory 366, and a non-volatile memory 368. The image-sensing units 340 are electrically connected to the A/D conversion unit 360, the editing and computing unit 362 is electrically connected to the A/D conversion unit 360, the driving unit 364, the volatile memory 366, and the non-volatile memory 368. The driving unit 364 is further electrically connected to a computer C via a physical line for transmitting the full inspecting image to the computer C.

The A/D conversion unit 360 receives the inspecting images with analog form (hereafter “analog inspecting images”) and configured to convert the analog inspecting images into inspecting images with digital form (hereafter “digital inspecting images”). The digital inspecting images are thereafter transmitted to the editing and computing unit 362.

The editing and computing unit 362 may be a field programmable gate array (FPGA). The editing and computing unit 362 receives the digital inspecting images and configured to provide a function of edition and operation. In particularly, the editing and computing unit 362 is configured to recombine and compensate uniformity of the digital inspecting images to produce the full inspecting image.

The editing and computing unit 362 may firstly store the digital inspecting images in the volatile memory 366, and then recombine the digital inspecting images and perform a uniformity compensating procedure. Due to the volatile memory 366 is an addressable memory, the arrangement of the digital inspecting images from different image-sensing units 340 stored in the volatile memory 366 can be mapped to the arrangement of the image-sensing units 340, which is beneficial to recombine the inspecting images. However, in the practical applications, the editing and computing unit 362 may configured to recombine and perform the uniformity compensating procedure of the digital inspecting images received from the A/D conversion unit 360, i.e., the editing and computing unit 362 may configured to recombine and perform the uniformity compensating procedure of the digital inspecting images which are not stored in the volatile memory 366.

In combining the digital inspecting images, the editing and computing units 362 receive the digital inspecting images from different image-sensing units 340; the digital inspecting images may be instantaneously captured by the image-sensing units 340 and converted in to digit form by the A/D conversion unit 360 or the digital inspecting image previously stored in the volatile memory 366.

Thereafter, the editing and computing unit 362 may find the repeated images in the digital inspecting images for positioning the digital inspecting images. As aforementioned, the repeated images are existed in the digital inspecting images, thus if the editing and computing unit 362 find the repeated image from two of the digital inspecting images means that the image-sensing units 340 for capturing the digital inspecting images having the repeated image are neighbor.

Thereafter, the editing and computing unit 362 configured to recombine the digital inspecting images to form the full inspecting image. With referring to FIG. 3 again; the editing and computing unit 362 may form the full inspecting image by combining the digital inspecting images captured by the 1 to P pixels of the left-most image-sensing unit 340 and the n+2 to P pixels of the central image-sensing unit 340. In short, the editing and computing unit 362 forms the full inspecting image by combining the digital inspecting images captured by the first image-sensing unit 340 and partial digital inspecting images do not include the repeated image captured by the other image-sensing units 340.

The editing and computing unit 362 may form the full inspecting image by combining the digital inspecting image captured by the 1 to P−n−1 pixels of the first and second image-sensing units 340 and the 1 to P pixels of the third image-sensing units 340. In short, the editing and computing units 362 generate the full inspecting image by the digital inspecting image captured by combining the last image-sensing unit 340 and the partial digital inspecting images do not include the repeated image captured by the other image-sensing units 340.

The editing and computing unit 362 may further form the full inspecting image by combining the digital inspecting image captured by the 1 to P−n−1 pixels of all of the image-sensing units 340. In short, the editing and computing units 362 may form the full inspecting image by combining partial digital inspecting images do not include the repeated image captured by all the image-sensing units 340.

The editing and computing unit 362 may further compensates uniformity of the digital inspecting images or the full inspecting image. More particular, the editing and computing unit 362 may first captures a dark image and a white image stored in the non-volatile memory 368, and then compare the full inspecting image to the dark image and white image, respectively, for adjusting the brightness of the digital inspecting images or the full inspecting image. The dark image is an image generated by capturing an entirely dark object, and the white is an image generated by capturing an entirely white object.

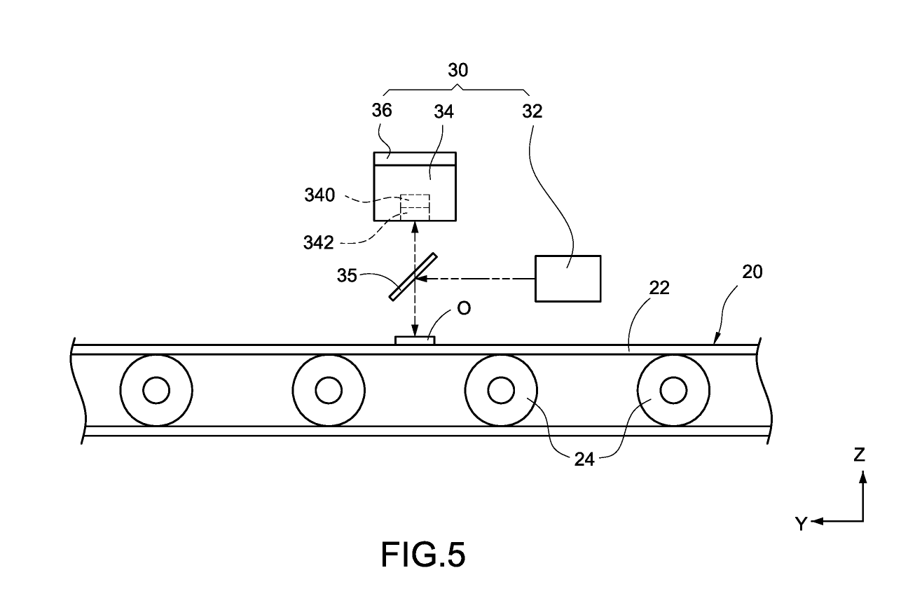

FIG. 5 is a side view of an optical inspection system according to a 2nd embodiment of the present disclosure. The optical inspection system shown in FIG. 5 is similar to that of shown in FIG. 2, and the same reference numbers are used in the drawings and the description to refer to the same parts. It should be noted that the optical inspection system shown in FIG. 5 inspects the object O by coaxial light.

In FIG. 5, the optical inspection system further includes a light splitter 35 arranged at an intersection of the optical routes which the light generated by the lighting module 32 goes through and the inspecting images reflected by the object O to the image-capturing module 34. The light splitter 35 is used to reflect the light generated by the lighting module 32 and pass the inspecting images through. The function and relative description of other components of the optical inspection system shown in FIG. 5 are the same as that of the 1st embodiment mentioned above and are not repeated here for brevity, and the optical inspection system shown in FIG. 5 can achieve the functions as the optical inspection system shown in FIG. 2 does.

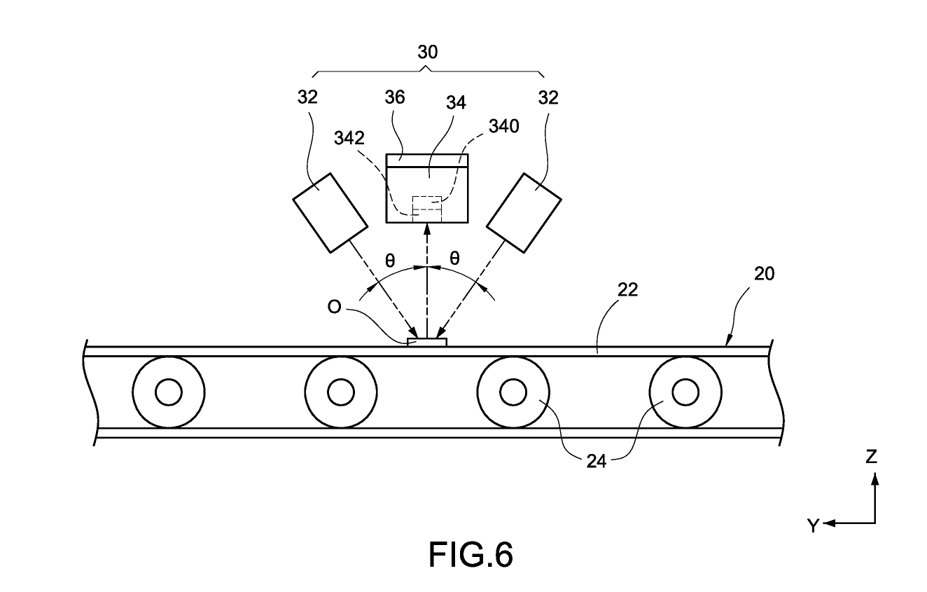

FIG. 6 is a side view of an optical inspection system according to a 3rd embodiment of the present disclosure. The optical inspection system shown in FIG. 6 is similar to that of shown in FIG. 2, and the same reference numbers are used in the drawings and the description to refer to the same parts. It should be noted that the optical inspection system shown in FIG. 6 includes two lighting modules 32.

The lighting module 32 are arranged at opposite side of the image-capturing module 34 along the Y axis, and an included angle θ is between axes of each light modules 32 and the image-capturing module 34 for providing different illuminant effect. The function and relative description of other components of the optical inspection system shown in FIG. 6 are the same as that of the 1st embodiment mentioned above and are not repeated here for brevity, and the optical inspection system shown in FIG. 6 can achieve the functions as the optical inspection system shown in FIG. 2 does.

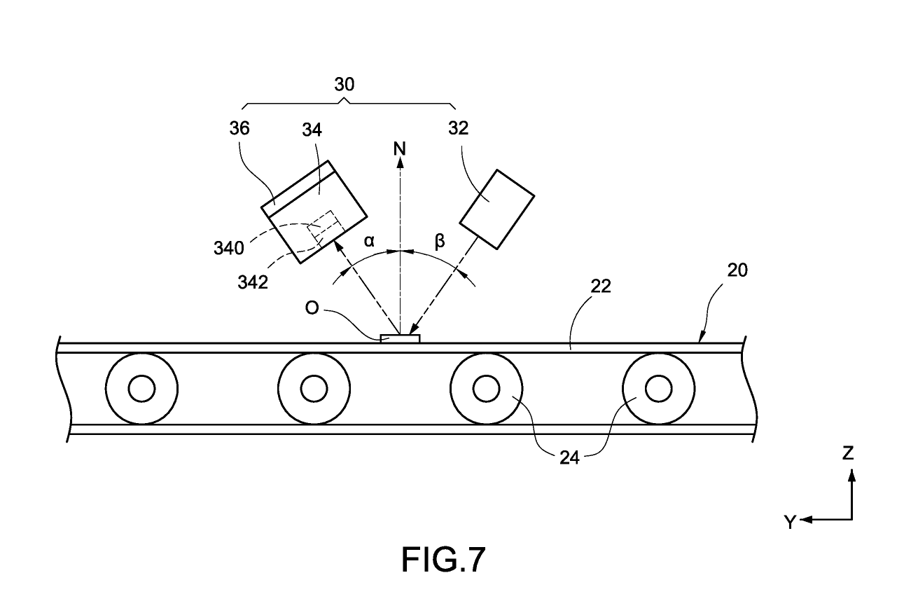

FIG. 7 is a side view of an optical inspection system according to a 4th embodiment of the present disclosure. The optical inspection system shown in FIG. 7 is similar to that of shown in FIG. 2, and the same reference numbers are used in the drawings and the description to refer to the same parts. It should be noted that an included angle α is between an axis of the image-capturing module 34 and the normal of the bottom surface of the object O, and another included angle β equal to the included angle α is between an axis of the lighting module 32 and the normal of the bottom surface of the object O.

The function and relative description of other components of the optical inspection system shown in FIG. 7 are the same as that of the 1st embodiment mentioned above and are not repeated here for brevity, and the optical inspection system shown in FIG. 7 can achieve the functions as the optical inspection system shown in FIG. 2 does.

In FIG. 1 and FIG. 2, the light module 32 and the image-capturing module 34 arranged at unilateral of the object O is capable of inspecting an opaque object O; in the practical application, however, the optical inspection system can be used for inspecting optical-transparent object O.

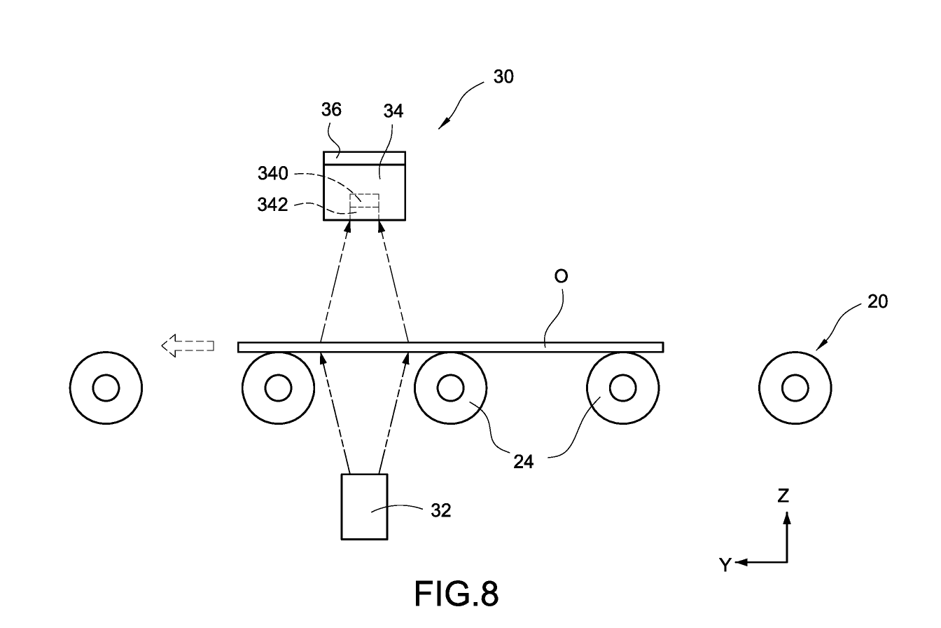

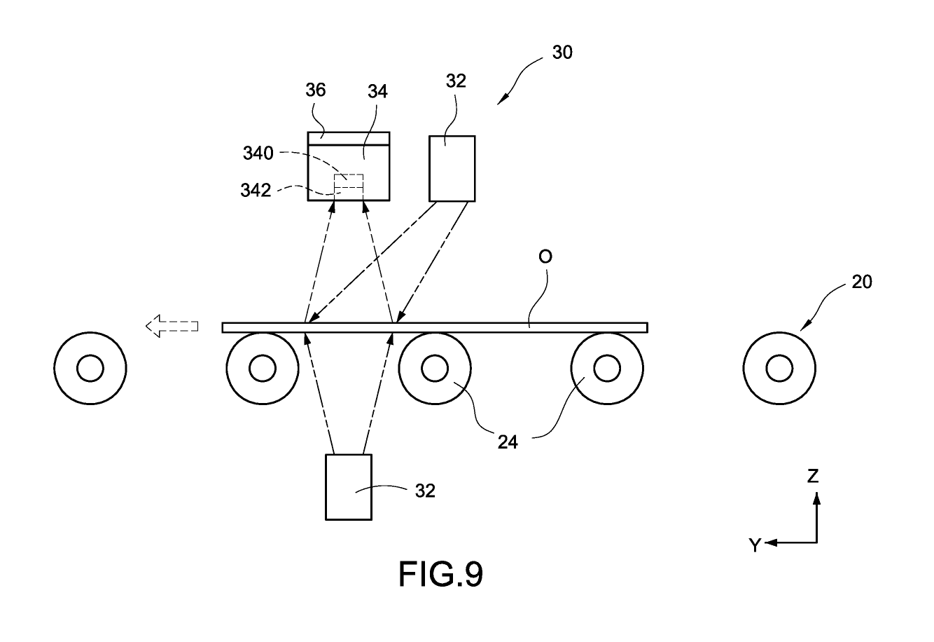

When the optical inspection system is user for inspecting an optical-transparent object O. the optical-transparent object O is directly arranged on the rollers 24. A driver is in mechanical communication with the rollers 24 to facilitate movement of the optical-transparent object O along a first direction Y, as can be seen in FIG. 8 and FIG. 9. In the other words, the conveyer belt 22 shown in FIG. 1 is not necessary for the optical inspection system applied to inspect the optical-transparent object O.

In FIG. 8, the lighting module 32 and the image-capturing module 34 are respectively arranged at opposite sides of the object O for providing a back-side inspection. Partial light generated by the lighting module 32 passes through the object O to form inspecting images, and each image-sensing unit 340 of the image-capturing module 34 is configured to capture the inspecting images passed through the object O.

In FIG. 9, the optical inspection system includes two lighting modules 32, which are respectively arranged at opposite sides of the object O for providing double-sided of light to illuminate the object O. The image-capturing module 34 is arranged at one side of the object O. Partial light generated by one of the lighting modules 32 passes through the object O to form inspecting images, and partial light generated by the other lighting module 32 is reflected by the object O to form the other inspecting images. Each image-sensing unit 340 of the image-capturing module 34 is configured to capture the inspecting images passing through and reflected by the object O.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the disclosure as defined in the appended claims.

What is claimed is:

1. An optical inspection system, comprising:
at least one lighting module, wherein each lighting module is configured to generate a light beam for illuminating an object;
a plurality of image-sensing units, wherein each image-sensing unit is configured to capture an inspecting image of the object, two adjacent inspecting images of the object has a repeated image; and
an editing and computing unit receiving the inspecting images captured by the image-sensing units and configured to position the inspecting images in accordance with the repeated images and then recombine the inspecting images for creating a full inspecting image.

2. The system of claim 1, wherein the editing and computing unit generates the full inspecting image by recombining the inspecting image provided by one of the image-sensing unit and multiple partial inspecting images provided by the other image-sensing units in accordance with the positions of the inspecting images, and the partial inspecting images do not comprise the repeated images.

3. The system of claim 2, wherein the editing and computing unit performs a uniformity compensation procedure by a dark image and a brightness image.

4. The system of claim 3, further comprising:
a non-volatile memory coupled to the editing and computing unit and configured to store the dark image and white image;
a volatile memory coupled to the editing and computing unit and configured to store the inspecting images; and
an analog and digital conversion unit electrically connected between the image-sensing units and the editing and computing unit and configured to convert the inspecting image with analog form captured by the image-sensing units into digital inspecting image for convenient edition, operation, and storage.

5. The system of claim 4, further comprising a driving unit coupled to the editing and computing unit and configured to transmit the full inspecting image to a computer.

6. The system of claim 1, wherein the editing and computing unit configured to form the full inspecting image by recombining a plurality of partial inspecting images provided the image-sensing units and in accordance with the positions of the inspecting images, the partial inspecting images do not comprise the repeated image in the previous or following image-sensing units.

7. The system of claim 6, wherein the editing and computing unit performs a uniformity compensation procedure by a dark image and a brightness image.

8. The system of claim 7, further comprising:
a non-volatile memory coupled to the editing and computing unit and configured to store the dark image and white image;
a volatile memory coupled to the editing and computing unit and configured to store the inspecting images; and
an analog and digital conversion unit electrically connected between the image-sensing units and the editing and computing unit and configured to convert the inspecting image with analog form captured by the image-sensing units into digital inspecting image for convenient edition, operation, and storage.

9. The system of claim 8, further comprising a driving unit coupled to the editing and computing unit and configured to transmit the full inspecting image to a computer.

10. The system of claim 1, wherein the lighting module and the image-sensing unit are arranged at unilateral of the object, and each image-sensing unit is configured to capture the inspecting image generated by the light beam from the lighting module and reflected by the object.

11. The system of claim 1, wherein the lighting module and the image-sensing units are arranged at opposite site of the object, and each image-sensing unit is configured to capture the inspecting image generated by partial light beam from the lighting module and passing through the object.

12. The system of claim 1, further comprising a light splitter arranged at an intersection of the optical route of the light beam generated by the lighting module and the inspecting image passing through.

13. The system of claim 1, further comprising a plurality of lighting module arranged at the opposite side of the object and respectively generates light beam for illuminate the object, the image-sensing units captures the light beam reflected by and passing through the object to form the inspecting images.

14. An image-processing method applied to an optical inspection system comprising:
capturing a plurality inspecting images from different sources;
sensing a plurality of repeated images from the inspecting images;
positioning the inspecting images in accordance with the repeated images; and
generating a full inspecting image in accordance with the positioned inspecting images.

15. The method of claim 14, wherein sensing a plurality of repeated images from the inspecting images further comprising:
performing a pre-procedure to the inspecting images to make the inspecting images with analog form into digital form.

16. The method on claim 15, further comprising:
performing a uniformity compensation procedure by a dark image and a brightness image.
